(19) United States
(12) Patent Application Publication
(10) Pub. No.: US 2008/0251263 A1
(43) Pub. Date: Oct. 16, 2008

(54) Deformed pipe method of extinguishing oil fires

(76) Inventor: Mahmoud Hamed Hamdy, Santa Cruz, CA (US)

Correspondence Address: John E. Menear, 1200 Capitola Road, #4, Santa Cruz, CA, 95062, US

(21) Appl. No.: 12/082,860

(22) Filed: Apr. 15, 2008

Related U.S. Application Data
(60) Provisional application No. 60/926,084, filed on Apr. 16, 2007.

(51) Int. Cl. E21B 35/00; A62C 3/06; A62C 39/00

(52) U.S. Cl. 169/46; 169/69; 166/55

(57) ABSTRACT

Equipment and method for extinguishing an oil fire where said oil is delivered through a 10 to 60 inch diameter pipe. The oil feed pipe is crushed in place, and the feed of oil to the fire is eliminated or largely reduced. This method is more economical than prior art methods, and response time is faster than prior art methods. With pipe crushing, explosives and other oxygen starvation techniques are not needed, but they could be used in combination.

### CROSS-REFERENCE TO RELATED APPLICATIONS

This application claims priority to U.S. provisional application 60/926,084 filed Apr. 16, 2007 by Mahmoud Hamed Hamdy entitled “Oil Pipelines-fire: the simple scheepest way to put off fire: petroleum fields, oil well, pipelines”.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to oil well fire fighting. In particular, the invention addresses oil fires where the oil is transported by one or more pipes to the site of the fire.

Oil fire can start due to accident or terrorist action. Once started, oil fires consume a valuable and diminishing resource, and pollute the air.

Quickly extinguishing the oil fire is important. The capacity to shorten the lifetime of the fire by a few hours offers a huge payback.

2. Description of Related Art

There are three common techniques of fire fighting.

The first is lowing the temperature of the fuel below the threshold for combustion. A common example of the temperature lowering method is when a municipal fire truck sprays water onto a burning house. Liquid water has a high heat capacity, and the phase change from liquid water to steam requires 101 kilocalories for each 18 grams. So, both heating the water and converting the water to steam extract energy from the fire. The result is a lower temperature.

The second method is depriving the fire of air, which contains roughly 20% oxygen. Without oxygen, the exothermic chemical reactions of the fire cannot continue, and combustion ceases. A common example of the air deprivation method is when someone smothers a small fire with a heavy blanket. When the oxygen beneath the blanket is consumed, the fire goes out.

The third method is removing the fuel from the fire. A common example of removing the fuel is used for forest fire control. The fire department intentionally sets a small fire in the oncoming path of a large fire to consume the fuel. When the large fire reaches the site of the intention burn, the fire cannot continue. Even though oxygen is present, there is nothing to burn.

Oil fires present extreme challenges.

The temperature of an oil well fire can exceed 7000 degrees F. This is high enough to melt any metals. Fire fighters, even with protective suits, must keep a safe distance from the flame. The time a fire fighter spends near the flame is limited.

The location of the fire is often distant from the equipment and skilled personnel that are required to fight the fire. Logistics to get the prior art fire fighting team into place are not trivial, and the logistics consume time.

Regardless of the dangers to fire fighting personnel, techniques of oil well fire fighting today focus largely on fighting the fire close to the flame. Air deprivation methods continue to be preferred.

Explosives are commonly detonated close to the flame center. The explosion consumes the oxygen, and is a form of air deprivation. Jet engine exhaust is sometimes directed toward the flame, which is another form of air deprivation.

Temperature reduction is also used. But the oil wells are typically located in arid counties, and large quantities of water may not be available. Furthermore, temperatures of 7000 degrees F (or more) require very large quantities of water. Temperature reduction is seldom the primary fire fighting technique.

A need exists for an oil well fire fighting method that can be applied quickly, even in remote geographical locations.

A need also exists for a method that can be applied distant from the combustion zone, where a lower temperature allows fire fighters to work faster and safer.

A need also exists for a method that is simple and requires minimal equipment. The purpose is to reduce the setup time.

### BRIEF SUMMARY OF THE INVENTION

The present invention is a predetermined force method that utilizes fuel deprivation to extinguish the oil fire. The central concept is to deform (by crushing) the oil pipe that leads to the fire. The pipe is crushed without moving the pipe. Equipment needed to crush the pipe is brought to the pipe site.

As the pipe is deformed by the force exerted, the internal cross section of the pipe is reduced to near zero. Oil flow to the fire site is either stopped or reduced. If crushing is complete, the oil flow is stopped and the fire ceases. If the crushing is incomplete, the oil flow is reduced and the flame lessens. A reduced oil flow simplifies the remainder of the fire fighting task.

Several embodiments of pipe crushing techniques are described. However, the embodiments are only examples of the larger principle of pipe crushing, and are not intended to limit the scope of the instant invention.

Forces and pressures involved in crushing a pipe in place are large. The output of a force generator must exceed the resistive strength of the pipe. The crushing device which contacts and deforms the pipe must be stronger than the pipe. And all linkage components between the force generator and the crushing device must be stronger than the pipe. The size of the force generator, crushing devices, and intermediate components are chosen based on the pipe's strength.

Force generators, which can exceed the strength of an oil pipe, are commercially available or can be built using known prior art technology. Crushing devices and linkage components are also commercially available, either as standard products or as special orders. Experimentation into hardware is not required. Only selection of specifications is needed. For example, where a chain is used, the same chain used for an aircraft carrier anchor might be chosen.

The most common force generators employ diesel oil power sources, and deliver forces through electric motors, hydraulic pistons or geared-down transmissions. However, the inventive concept is not limited to diesel oil power sources, electric motors, hydraulics, or geared-down transmissions.

Crushing devices described in the following paragraphs include heavy chains and metal blocks. However, the inventive concept is not limited to heavy chains and metal blocks.

Linkage components described below include torsion bars that twist a heavy chain, rings which connect a torsion bar to a heavy chain, metal blocks which move toward each other, lever arms, and a fulcrum for lever arms.

The pipe crushing method of fuel deprivation may be applied anywhere along the length of pipe that delivers oil to the fire site. Convenience, practicality, and distance from the fire are factors in deciding where the pipe will be crushed.

However, with all other factors equal, crushing the pipe distant from the fire is advantageous because the temperature is lower. If the crushing location is very far from the fire, a heat shield to protect the fire fighter may not be needed. If the pipe is crushed close to the fire, a high temperature heat shield is appropriate.

Although fuel deprivation is the central strategy embodied in this instant invention, this invention may be coupled with air deprivation or temperature lowering.

Objects of the invention include (1) deforming (by crushing) the oil feed pipe until the flow of oil through the pipe is stopped, and the fire is extinguished, (2) crushing the oil feed pipe until the flow of oil through the pipe is reduced, and a much smaller fire remains, (3) providing an option to fight the fire at a distance from the fire, where temperatures are less, (4) providing an option to fight the fire safely and comfortably, (5) extinguishing the fire as quickly as possible, (6) reducing the amount of equipment needed and the time to get that equipment to the fire site, and (7) minimizing the amount of lost oil.

### BRIEF DESCRIPTION OF THE SEVERAL VIEWS OF THE DRAWINGS

FIG. 1 is a schematic that shows oil flowing from an oil source through an oil pipe to the site of an oil fire. This is the type of oil fire that the instant invention is designed to extinguish.

FIG. 2 is a schematic that shows an oil pipe with a section of the pipe partially crushed by the application of external force. After crushing, the cross section available to transport oil has been reduced. As shown, the oil pipe delivers only a fraction of the original flow to the fire. If no oil could get through the crushed section, the oil fire would cease.

FIG. 3 shows one embodiment of the pipe crushing method. A heavy chain has been positioned around the pipe. Then the chain is twisted until the oil pipe is crushed by the decreasing diameter of the chain loop which encircles the oil pipe. In this embodiment, force is applied by a diesel engine or an electric motor.

FIG. 4 shows a planar diagram of another embodiment. Two hardened metal blocks are placed on opposite sides of the oil pipe. Force is applied to the top metal block, which moves it toward the bottom metal block. The oil pipe is crushed between the blocks.

FIG. 5 again shows an oil pipe crushed between two hard metal blocks. In this embodiment, a hydraulic force is applied.

FIG. 6 describes yet another embodiment. An oil pipe is crushed by two hard blocks that are adjoined to lever arms, and the two lever arms originate from a common fulcrum. This embodiment benefits from the mechanical advantage of a secondary lever.

### DETAILED DESCRIPTION OF THE INVENTION

When an oil fire depends upon an oil pipe to deliver oil to the site of the fire, crushing the oil pipe restricts flow through the pipe and provides a superior way to extinguish the fire. Not only is this method faster than air deprivation or temperature lowering, but pipe crushing can be performed at a distance from the fire site. Worker safety is improved by moving the fire fighting process away from the intense heat.

In March 2008, spot world oil prices exceeded $100/barrel. If a fire consumes 10 barrels/second, reducing the fire fighting time by 1 hour translates into $3,600,000. Reducing the fire fighting time by 24 hours translates into $86,400,000.

The environmental impact is an additive loss.

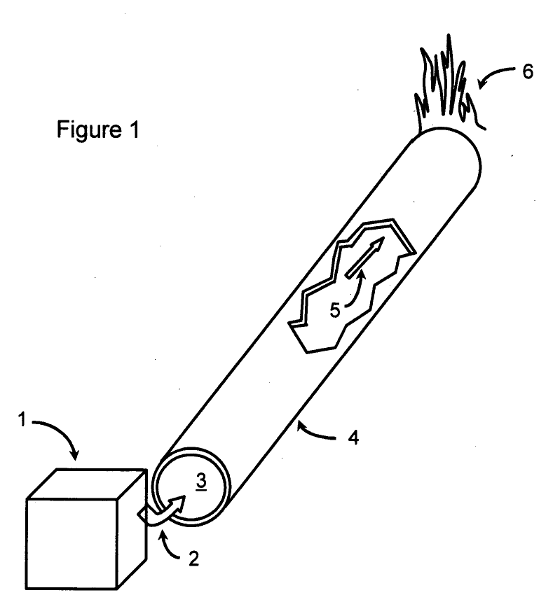

Refer to FIG. 1. A source of oil 1 is fed into the inlet end 3 of an oil pipe 4 in flow direction 2. Oil flow 5 within the pipe delivers the oil to the fire 6 site, where it is consumed. The oil fire 6 will continue as long as oil and air are present, and the combustion temperature is exceeded.

Prior art fire fighting is largely performed at the fire 6 site. Due to extreme temperatures, heat shields are needed to protect the fire fighters.

The current invention extinguishes the fire at a distance from the fire, where the temperature is lower and work can proceed at a faster rate. Heat shields may be needed, but they are not necessary for every fire fighting job.

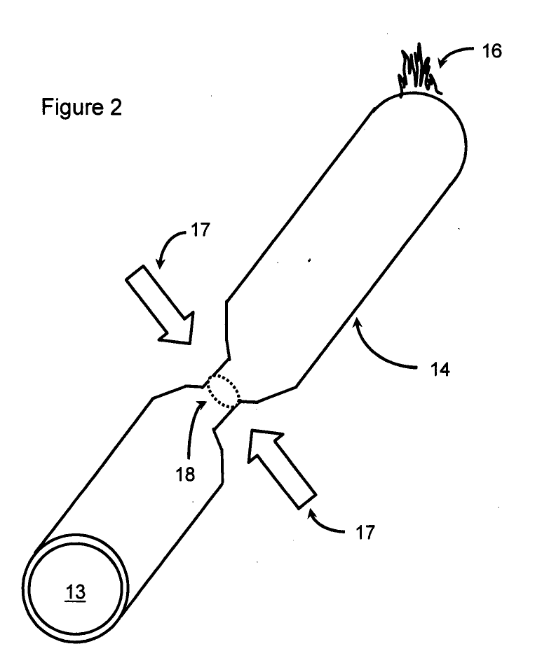

FIG. 2 shows the effect of the invented fire fighting method. A section of the oil pipe 14 has been crushed by external forces 17 that push the circumference of the oil pipe 14 toward the center of the oil pipe 14. The uncrushed oil pipe has an original oil carrying cross section 13 that may be up to 60 inches in diameter. After crushing, the restricted cross section 18 is much smaller. And the resulting fire 16 is proportionally smaller.

In the ideal case, crushing would completely stop the flow of oil. That is, the restricted cross section 18 becomes essentially zero. The fire 6 would be extinguished without further effort.

The pipe crushing method has the following essential steps:

(1) select a section of oil pipe to be crushed.

(2) place the crushing device(s) into position.

(3) connect the crushing device to a force generator that exceeds the strength of the oil pipe. Be sure that all connectors and linkage components are stronger than the oil pipe itself.

(4) crush the pipe.

Additional steps that may be appropriate include:

(1) clear a zone around the oil pipe for equipment. If the pipe is buried or partially buried, it may be necessary to dig under the oil pipe.

(2) place a heat shield between workers and the fire.

(3) stop and reposition the crushing devices to further reduce the oil flow.

(4) open one or more pressure release safety valves that serve the pipe to decrease oil pressure within the pipe.

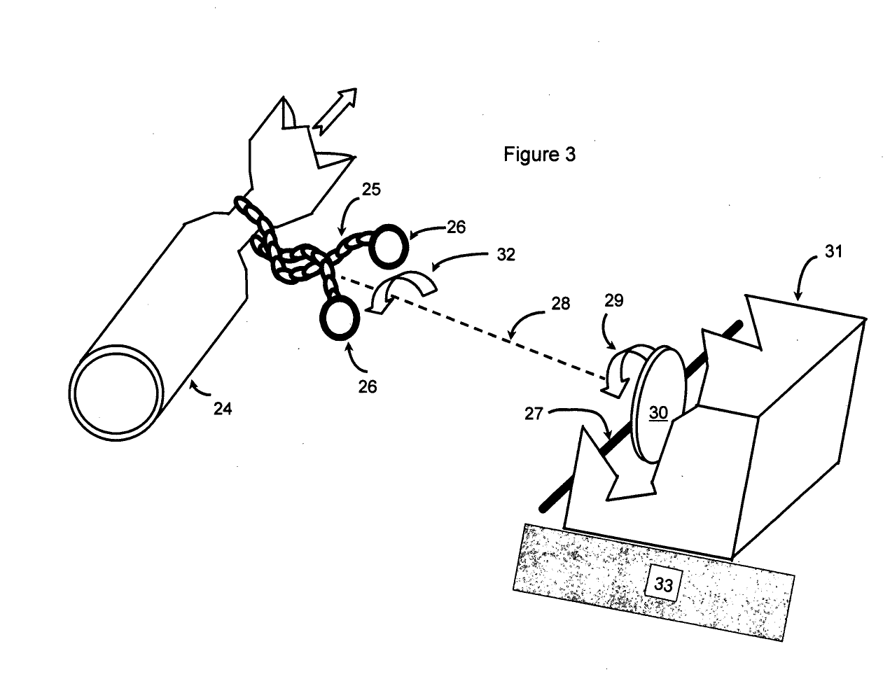

FIG. 3 shows a first embodiment of the invention. In this embodiment, the crushing device is implemented as a heavy chain 25. The chain 25 is placed around the oil pipe 24, and is connected to a heavy torsion bar 27. In this diagram, the connection between chain 25 and the torsion bar 27 is made by rings 26 which slide over the opposite ends of the torsion bar 27. Note that the use of rings 26 is not limiting. Other common methods of connection may be used, and remain within the scope of this embodiment.

A force generator 31 that is firmly attached to the ground 33 or to a mobile vehicle rotates a torsion bar holder 30. As drawn, the torsion bar 27 rotates along an axis 28 in the counterclockwise direction 29. This causes the rings 26 and chain 25 to also wrap in the counterclockwise direction 32. As the chain wraps, inward force is applied to the circumference of the oil pipe 24 until the cross section of oil pipe 24 is reduced.

A typical force generator 31 may include a diesel engine, an electric motor, hydraulics, or a combination. For example, a diesel engine can drive a turbine that creates electricity for an electric motor.

Diesel engines, electric motors, and hydraulics do not limit the inventive concept. Other prior art systems of force generation may be used, and still maintain the inventive concept.

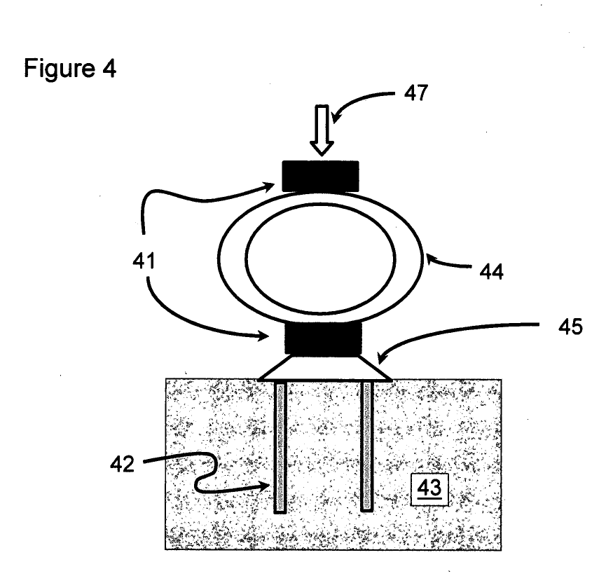

In FIG. 4, another embodiment is described. In this embodiment, an oil pipe 44 is held between two crushing devices 41, and a downward force 47 is applied to the upper crushing device 41. The bottom crushing device 41 is positioned on a support stand 45 that is held firmly on the ground 43 by a set of support rods 42.

In this embodiment, the crushing devices 41 are implemented as metal blocks. However, there is no requirement for either metal composition or a block shape. The requirement is that the crushing devices are hard enough to withstand the forces developed during crushing. In one variation, the crushing devices 41 have a shape which prevents the oil pipe 44 from moving.

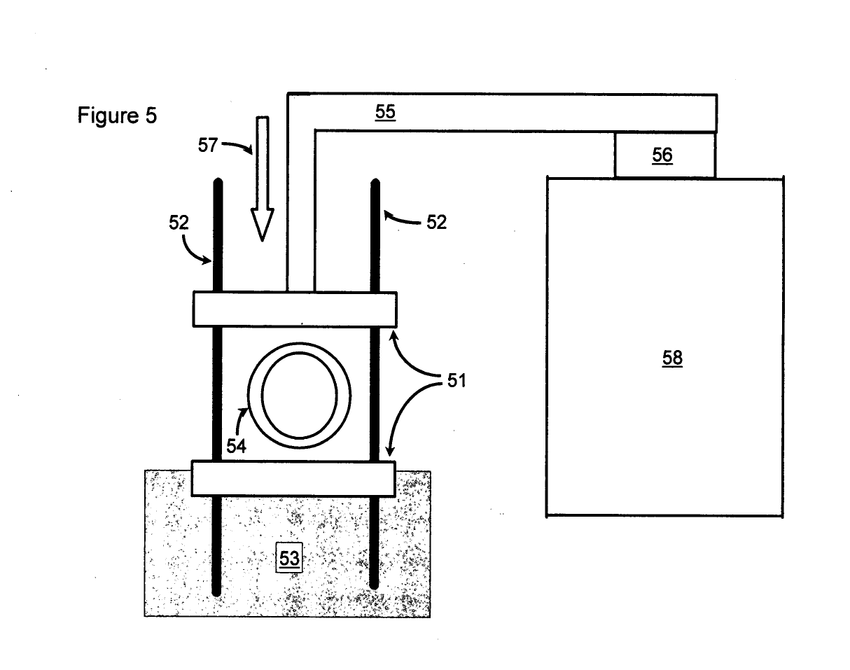

FIG. 5 describes yet another embodiment. In this method, the oil pipe 54 is crushed by a hydraulic arm 55 that applies a downward crushing force 57 to the top crushing device 51. As shown, the force generator 58 and the hydraulic piston 56 are located close beside the oil pipe 54. In a variation, the force generator 58 is stabilized to prevent tipping.

The crushing devices 51 have holes through which the support rods 52 pass. The same support rods 52 or an alternate set stabilize the bottom crushing device 51 to the ground 53.

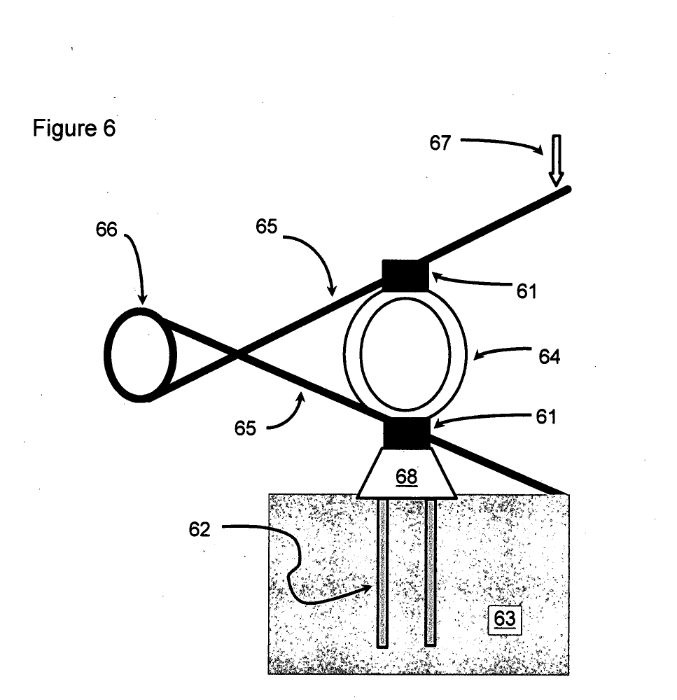

FIG. 6 shows yet another embodiment. Here the crushing device is implemented as two lever arms 65 are joined at a common fulcrum 66. Each lever arm 65 possesses a crushing surface 61, and the oil pipe 64 is held between the two crushing surfaces 61. A force 67 is applied downward on the top lever arm 65. Since this constitutes a classic secondary lever system, the force applied at the top crushing surface 61 is larger than the applied force 67.

The bottom crushing surface 61 is held onto a stand 68, which is stabilized on the ground 63 by support rods 62.

In a variation of this design, the lever arms and fulcrum can be rearranged to form a primary lever system, where the fulcrum is located between the applied force and the pipe. In this variation, forces open one side of the primary lever and crush the pipe on the other side. A hydraulic piston to deliver force is a good choice for this variation.

Oil pipes may have a resistive strength of 1200 Newtons/mm² and all equipment used to crush the oil pipe must be able to withstand 1200 Newtons/mm².

Calibrated diagnostic gauges that indicate force levels and pressure levels up to 1200 N/mm² are connected to the force generator. The gauges may be stationed in a panel with other accessories.

The resistive strength (in pressure units) of 1200 Newtons/mm² was taken from the following table of oil pipe strengths. The maximum yield strength in the table is 1171 Newtons/mm², which was rounded to 1200 Newtons/mm².

| Oil Country | | | | | | | | | |
|---|---|---|---|---|---|---|---|---|---|
| Tubular Good | | | | | | | | | |
| (OTCG) | | | | | | | | | |
| Steel Grades | | | | | | | | Yield Strength | |
| Low Alloy Grades | | | | | | | | (0.2% proof | |
| Yield strength | API Grade | % Alloy content | | | | | | stress) | Tensile Strength |
| (ksi) | Code | C | Mn | Ni | Cr | Mo | Cu | (N/mm2) | min (N/mm2) |
| 40 | H40 | 0.5 | 1.5 | | | | | 276-552 | 410 |
| 55 | K55 | 0.5 | 1.5 | | | | | 379~552 | 655 |
| 75 | C75-1 | 0.5 | 1.7 | 0.5 | 0.5 | 0.40 | 0.5 | 517~620 | 665 |
| 90 | C90-1 | 0.35 | 1.9 | 0.9 | 1.2 | 0.75 | | 620~724 | 690 |
| 95 | T95-1 | 0.35 | 1.2 | 0.9 | 1.5 | 0.85 | | 655~758 | 724 |
| 125 | Q125 | 0.35 | 1 | 0.9 | 1.2 | 0.75 | | 860~1035 | 93 |
| 140 | | 0.3 | 1 | | 1.6 | 1.1 | 0.05 | 965~1171 | 1034 |

It is clear that other embodiments are possible within the inventive scope. The embodiments described above are only examples.

The invention claimed is:

1. A method of extinguishing an oil fire where said oil is delivered to the site of said fire through an oil pipe comprising:
selecting a portion of said oil pipe to be crushed;
placing a crushing device(s) around said oil pipe or at opposite sides of said oil pipe;
connecting a force generator to said crushing device;
crushing said oil pipe with a force from said force generator that is applied to said crushing device(s); and
preventing or restricting said oil from flowing to said fire by said crushing.

2. Claim 1 where said crushing device includes a chain that is placed around said oil pipe.

3. Claim 2 where said chain is connected to a torsion bar, and said torsion bar twists said chain.

4. Claim 1 where said crushing device includes crushing surfaces placed at opposite sides of said oil pipe, and said crushing surfaces are driven toward each other.

5. Claim 1 where said crushing devices comprise metal blocks.

6. Claim 1 where said crushing devices include lever arms that provide the mechanical advantage of a secondary or primary lever system.

7. Claim 1 where the bottom said crushing device is stabilized to the ground with support rods.

8. Claim 1 further comprising:
clearing a space around the pipe to place equipment.

9. Claim 1 further comprising:
placing a heat shield between workers and said fire.

10. Claim 1 further comprising:
stopping after the first crushing step to reposition said crushing devices.

11. Claim 1 further comprising:
opening one or more pressure release safety valves that serve said oil pipe.

12. Claim 1 where said high force generator utilizes hydraulics to develop the forces required to crush said pipe.

13. Claim 1 where said high force generator utilizes electric motors to develop the forces required to crush said pipe.

14. Claim 1 where said force generator develops enough force to create a crushing pressure of 1200 N/mm² at the oil pipe surface to be crushed.

15. Claim 1 where said oil pipe has a diameter of 10 to 60 inches.

16. An apparatus for extinguishing an oil fire by crushing an oil pipe comprising:
a force generator that can produce 1200 N/mm² at the oil pipe surface to be crushed;
a torsion bar that can withstand 1200 N/mm²; and
a heavy-duty chain that can withstand 1200 N/mm² and connects to said torsion bar.

17. An apparatus for extinguishing an oil fire by crushing an oil pipe comprising:
crushing devices that are placed on opposite sides of an oil pipe;
crushing surfaces that contact the outside surface of said oil pipe;
a force generator that delivers a crushing force to at least one said crushing device
and is capable of delivering 1200 N/mm² to the oil pipe surface to be crushed; and
a means for stabilizing the apparatus on the ground or to a vehicle.

18. Claim 17 where said means comprise support rods driven into said ground.

19. Claim 17 where said means comprise support rods and bolts driven into said vehicle.

20. Claim 17 where said force generator includes a diesel engine, an electric motor, or hydraulics.
